(19) United States
(12) Patent Application Publication
(10) Pub. No.: US 2005/0194346 A1
(43) Pub. Date: Sep. 8, 2005

(54) Model of beverage container

(76) Inventor: Armando Diaz Alonso, Cancun (MX)

Correspondence Address: ANDERSON, KILL & OLICK, P.C., 1251 AVENUE OF THE AMERICAS, NEW YORK,, NY, 10020-1182, US

(21) Appl. No.: 10/971,587

(22) Filed: Oct. 22, 2004

(30) Foreign Application Priority Data
Jul. 7, 2004 (MX) PA/U/2004/000139
Mar. 2, 2004 (MX) PA/U/2004/000056

(51) Int. Cl. A61J 1/00

(52) U.S. Cl. 215/387

(57) ABSTRACT

The present invention, is a beverage container, which can be easily dismantled through a pressure joint, so that a number of containers may be stacked up by stacking the lower base of one container to the lower base of another and by stacking up the upper part of one to another thereby providing consumers with a broader, more effective container. The container can be assembled for drinking purposes in different colors and may be shipped and/or stored by stacking up the separate parts. This will reduce and save space when being packed for sale and distribution purposes.

### FIELD OF THE INVENTION

The present invention refers to a beverage container which can be disassembled into at least an upper part and a lower base with each part adapted to fit into the same part of another container to form a stack of equal parts. The container is easily assembled and dismantled by a pressure coupling mechanism. The disassembly of the container into parts reduces space for packing and storing for transportation, distribution and sale in the market.

### BACKGROUND OF THE INVENTION

Within the human ambit, consumers have been searching a way to satisfactorily obtain an effective use for the diverse types of beverage containers, as well as the power to differentiate the broad range of containers currently existing in the market. Unfortunately, consumers' needs have not been met, since there are only one-piece whole containers available commercially, which do not provide the functionality and advantages of the container of the subject invention a main feature of which is its disassembly into separate parts of special shape and configuration. The separate parts readily interfit into the same parts of equivalent containers to form separate stacks of equal lower and upper parts, respectively. This application is based upon a prior application filed by me to which File No. PA/U/2004/000056 dated Mar. 2, 2004 Folio PA/E/2004/010846 was assigned.

### SUMMARY OF THE INVENTION

The beverage container of the present invention permits the container to be dismantled through a pressure joint and permits the lower base and upper part to be separated and stacked with the lower base and upper part of other identical container parts. This provides consumers with a broader, more effective function over the diverse beverage containers already known.

### BRIEF DESCRIPTION OF THE DRAWINGS

In order that the invention can be clearly understood and put into practical effect the invention will now be described in reference to the accompanying drawings which illustrate non-limiting embodiments of the present invention, and wherein:

FIG. 1 is an exploded front perspective view of the assembled container.

FIG. 2 is an exploded front perspective view of the unassembled container.

FIG. 4 is a front perspective view of the upper part.

FIG. 5 is an aerial side perspective view of the upper part and base of the container.

FIG. 6 is front perspective view of the way in which the upper part and the lower part of the container shall be coupled.

FIG. 7 is a front perspective view of the upper part and the lower part duly coupled.

FIG. 8 shows in a detailed and frontal manner the upper and lower parts of the container, wherein the possibility to pile up the container is properly depicted.

### DETAILED DESCRIPTION OF THE INVENTION

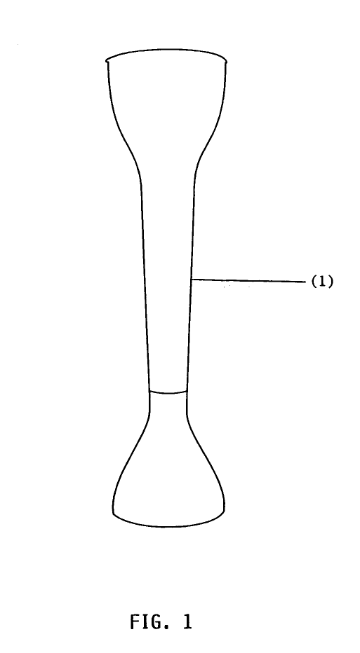

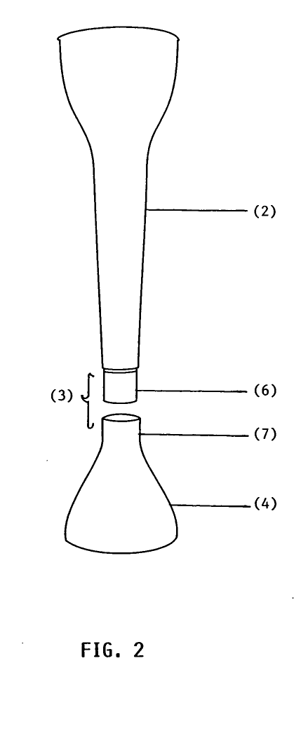

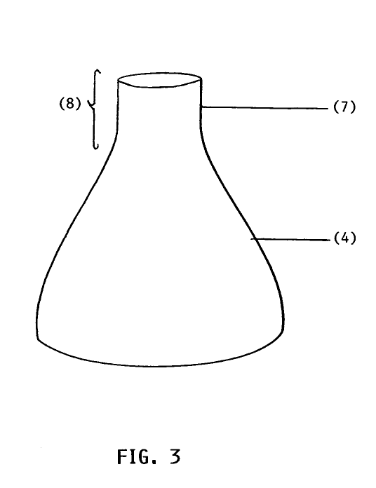

The present invention is directed to a beverage container as shown in FIG. 1, which is comprised of two parts: an upper part and a lower base as shown in FIG. 2. FIG. 1 shows the container in full, depicting a container (1) preferentially called yard, which may be made of plastic and comprising an upper part (2), a joint (3) and a base (4). The upper part (2) of the container has an enlarged body with a bottom part and an open-end upper part, so that its interior defines a cavity where the beverage shall be containerized having a cup-shaped form with a circular section that widens from the base towards the upper part. The cavity in the upper part has a bottom defined by a wall in the joint (3). The base of the container (4) includes a cavity (5). A corresponding container as conceived by applicant is disclosed in an application filed concurrently herewith and entitled Container With Promotional Base, the disclosure of which is incorporated herein by reference.

Likewise, experts may vary the configuration of the cup (2) of the container shown on FIG. 1, which contains the beverage, e.g., it may be a section shaped in the form of a quadrangle, oval, triangle, circle, or otherwise geometrical form. Likewise, the container may be transparent or colored.

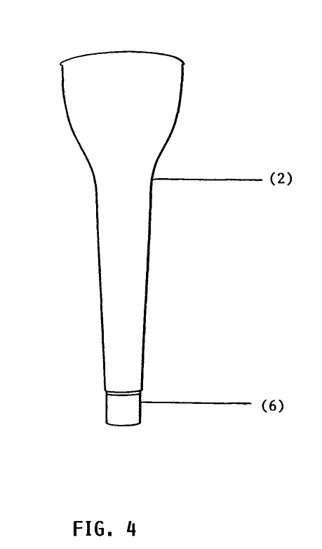

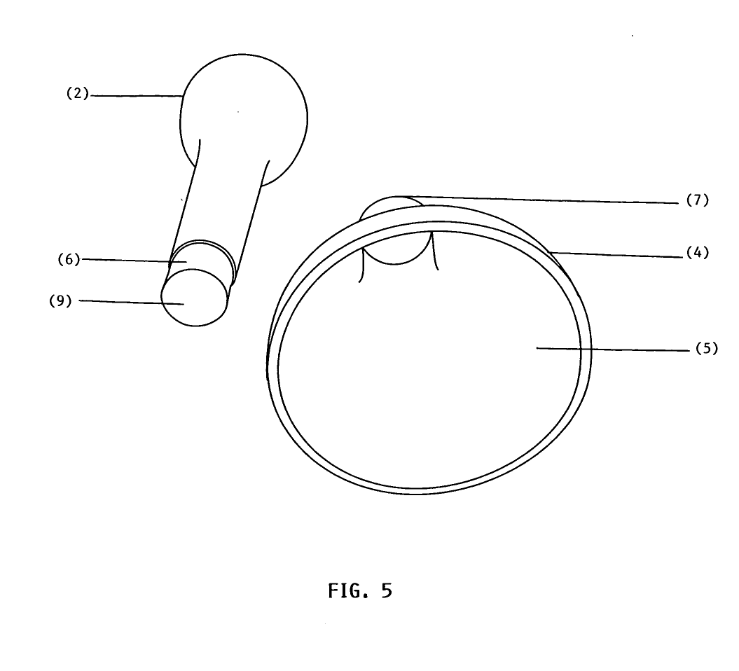

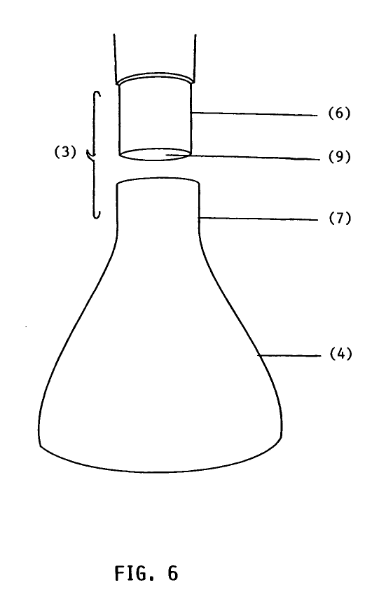

FIGS. 2 and 4 show in a detailed manner the upper part or cup (2) referencing the coupling of the cup with the base of the container, specifically called the intermediate part or joint (3), whose function is to connect the upper part (2) of the container with the base of the container (4). It is mentioned that the bottom of the cup (2) has a wall (9). The joint (3) is a pressure coupling in which a male J part (6) and a female part (7) are utilized, so that they supplement each other, and when in contact and pressed against each other the upper part of the container (2) is coupled to the base of the container (4); concerning FIG. 6, it is shown that that the lower part bears the female part (7), including a section with certain height (8), while FIG. 4 shows that the upper part bears the male part (6), with a section substantially narrower than the female part (7), so that the male part may be introduced into the section of the female part (7) achieving a firm coupling that provides the necessary tightness when the container is being used.

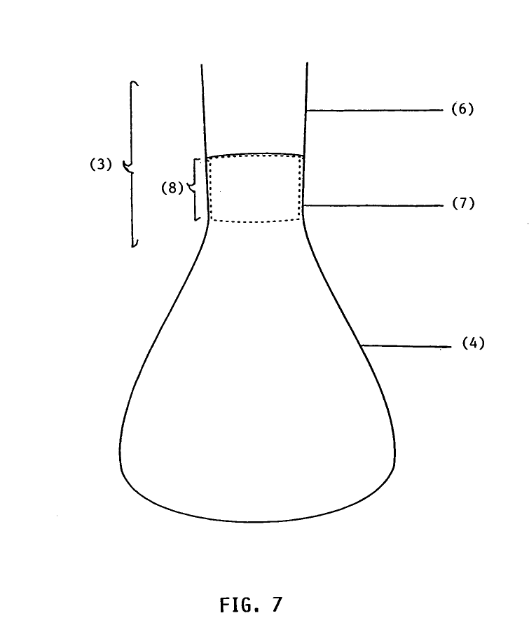

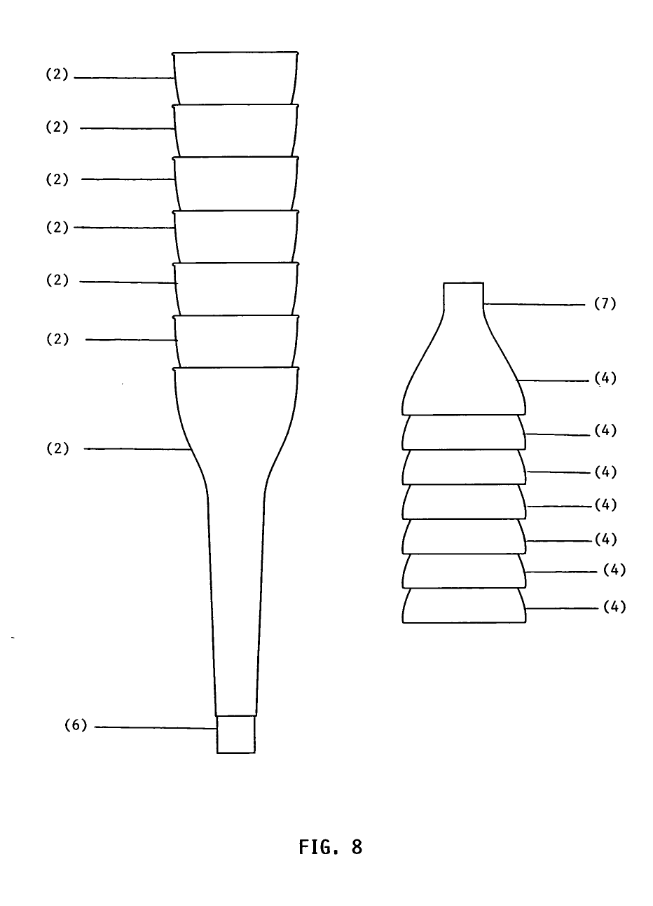

It is further provided that the male part has a diameter smaller than the female section. However, the outside wall of the male part must be configured in such a manner that upon coupling both parts the outside wall of the male part may be substantially equal to the outside wall of the female part and the joint may not be visually discontinued, as shown on FIG. 7.

The above described embodiment contemplates the most important advantages of the container based upon simplicity in its manufacturing, since by having the upper part or cup (2) sealed to the base the air tightness necessary to contain the beverage is obtained.

It may be noted in FIG. 6 that the container may be transported unassembled, which favors the space for storage purposes, since equal sections may be coupled and more containers may be transported while occupying a minimum storage space, and once utilized, a person may easily assemble the container for its immediate use.

1) A container that may be dismantled in two parts with each part adapted to fit an equal part of another container so that they may be stacked up, comprising an upper part (2) formed from an enlarged body that has a bottom part and an open-end upper part, in which the inside defines a cavity where the beverage shall be containerized; a joint (3) that couples to the base of the container (4) defines a cavity (5).

2) A container with base according to claim 1 comprising a male part (6) that includes a section of certain height for the joint (3) and a female part (7) with a section substantially bigger than the male part (6), so that the male part may be introduced into the female part (7) accomplishing a firm coupling that provides the necessary tightness when the container is being used.

3) A container with based according to claim 2, wherein the female part is located in the based of the container and the male part is located in the upper part of the container.

4) A container with based according to claim 2, wherein the male part and the female part have a wall with a length substantially equal.

5) A container with base according to claim 1, that is transparent or colored.

6) A container with based according to claim 1 made of plastic.

7) A container with base according to claim 1, wherein the upper part is a section shaped in the form of a quadrangle, oval, triangle or circle.

8) A container with base according to claim 1, wherein the upper part may be shaped in the form of any geometrical figure.
